(19) United States
(12) Patent Application Publication
(10) Pub. No.: US 2024/0174531 A1
(43) Pub. Date: May 30, 2024

(54) Battery Material

(71) Applicant: JOHNSON MATTHEY PUBLIC LIMIITED COMPANY, London (GB)

(72) Inventor: Yang Liu, Reading, Berkshire (GB)

(21) Appl. No.: 18/285,086

(22) PCT Filed: Mar. 31, 2022
(86) PCT No.: PCT/GB2022/050809

§ 371 Date: Sep. 29, 2023

(30) Foreign Application Priority Data
Apr. 1, 2021 (GB) 2104700.6

(51) Int. Cl. C01G 45/12; H01M 4/505; H01M 4/62; H01M 10/0525

(52) U.S. Cl. CPC C01G 45/1228; H01M 4/505; H01M 4/625; H01M 10/0525; C01P 2002/60; C01P 2002/72; C01P 2002/76; C01P 2002/77; C01P 2004/03; C01P 2004/61; C01P 2006/40

(57) ABSTRACT

The present invention provides a lithium metal oxide composition, a method of synthesis of said composition, an electrode and a battery incorporating said composition, and a use of said composition. The lithium metal oxide composition has a cation-disordered rock salt structure, and a non-stoichiometric composition such that lithium vacancies are present in the material. The lithium metal oxide composition has a general formula: Li₁₊ₓM′_{y}M_{1-x-y-β}O₂, wherein M comprises a transition metal element, M′ comprises a redox-inactive d⁰ element, and wherein 0<x≤0.7, 0<y≤0.7, and 0<β≤0.1. Such materials may provide satisfactory, improved, or excellent electrochemical performance at relatively low cost, and without the need for fluorination.

### FIELD OF THE INVENTION

The present invention relates to materials suitable for use in secondary lithium-ion batteries, and particularly, although not exclusively, to materials which have utility as cathode materials in secondary lithium-ion batteries.

### BACKGROUND

Lithium metal oxide materials having a layered structure are well-known for their utility as cathode materials in secondary lithium-ion batteries, in particular rock-salt type layered lithium metal oxides of the general composition LiMO₂, where M is a metallic species or a mixture of several such species.

For many years, cation disorder has been considered to be detrimental to Li+ transport (and thus to the reversible capacity) of intercalation-type electrodes. However, more recently work has shown that material having a disordered rock salt structure (sometimes referred to as ‘DRX materials’) may also have utility in secondary lithium-ion batteries.

A DRX material is a layered structure in which the cations are randomly arranged. The general formula of such materials is Li₁₊ₓM_{1-x-y}M′_{y}O₂, where M is a transition metal, and M′ is redox-inactive d⁰ element. The role of the redox-inactive d₀ element is described by Chen G. et al in ‘Role of Redox-Inactive Transition-Metals in the Behaviour of Cation-Disordered Rocksalt Cathodes’, Small, Vol. 16, issue 22, Jun. 4, 2020.

Previous work in the areas of DRX materials has shown that these materials can provide suitable electrochemical performance—and in particular, can exhibit higher capacities than traditional layered oxide cathode materials.

For example, US20180053934 is a relatively early disclosure demonstrating the possibility utility of disordered rock salt materials. It discloses a discharge-positive (cathode) rock salt type electrode material for a lithium secondary battery with cation mixing. The disclosed materials exhibit a reversible capacity of more than 150 mAh/g.

Some research into disordered rock salt materials has shown that use of fluorinated disordered rock salt type materials can further enhance the capacity of such materials. Fluorine contained disordered rocksalt materials are generally synthesised via high energy milling process using Lithium Fluoride (LiF). For example, EP3607599 discloses fluorine substituted cation-disordered lithium metal oxides for high capacity lithium-ion battery electrodes and methods of making same. However, known processes for producing fluorinated DRX materials are difficult to scale-up for industrial purpose. Furthermore, use of fluorine can provide a number of hazards: LiF is classified as a toxic and dangerous chemical according to the Globally Harmonized System of Classification and Labelling of Chemicals (GHS). Serious side reactions with the crucible (Al₂O₃) have also been observed during high temperature calcination (solid state reaction) of samples containing fluorine.

Accordingly, it would be advantageous to provide materials having similar or greater electrochemical performance as known fluorinated disordered rock salt materials, but which do not suffer the same difficulties in production associated with fluorinated materials.

The present invention has been devised in light of the above considerations.

### SUMMARY OF THE INVENTION

The present inventors have surprisingly found that it is possible to synthesise materials having a disordered rock salt structure containing lithium vacancies, and that such materials may provide satisfactory, improved, or excellent electrochemical performance at relatively low cost, and without the need for fluorination.

In a general aspect, the present invention therefore provides a lithium metal oxide composition having cation-disordered rock salt structure, and having a non-stoichiometric composition such that lithium vacancies are present in the material. Lithium vacancies may also be more generally referred to as ‘cation vacancies’.

In a first aspect, the present invention provides a lithium metal oxide composition having a general formula: Li₁₊ₓM′_{y}M_{1-x-y-β}O₂, wherein M comprises a transition metal element, M′ comprises a redox-inactive d⁰ element, wherein:

0<x≤0.7

0<y≤0.7

0<β≤0.1

and wherein the lithium metal oxide has a cation-disordered rock salt structure. Preferably, x+y+β is less than 1.

The term “cation-disordered rock salt structure” is used herein to describe a structure having a cubic close-packed crystal lattice in which oxide anions are arranged in a cubic close-packed lattice, cations occupy the octahedral sites in the lattice, and wherein there is a disordered arrangement of cations on the cation lattice. A DRX material typically has a symmetry belonging to the space group Fm-3m.

x is in the range of 0<x≤0.7. In some cases, x is greater than or equal to 0.01, 0.02, 0.03, 0.04, 0.05, 0.1, 0.15, 0.2, 0.3, 0.4, 0.5, or 0.6. In some cases, x may be less than or equal to 0.6, 0.5, 0.4, 0.3, 0.2, 0.15, 0.1 or 0.05. For example, x may be in a range of e.g. 0.01≤x≤0.7. In some preferred examples, x is in a range of from 0.01≤x≤0.5.

y is in the range of 0<y≤0.7. In some cases, y is greater than or equal to 0.01, 0.02, 0.03, 0.04, 0.05, 0.1, 0.15, 0.2, 0.3, 0.4, 0.5, or 0.6. In some cases, y may be less than or equal to 0.6, 0.5, 0.4, 0.3, 0.2, 0.15, 0.1 or 0.05. For example, y may be in a range of e.g. 0.01≤y≤0.7. In some preferred examples, y is in a range of from 0.01≤y≤0.5, 0<y≤0.4, or 0.01≤y≤0.4.

β can be considered as the atomic proportion of lithium vacancies present in the lithium metal oxide composition. β is in the range of 0<β≤0.1. As β is greater than 0, some lithium or cation vacancies are present in the material. In some preferred embodiments, B is greater than or equal to 0.001, 0.005, 0.01, 0.02, 0.03, 0.04, 0.05, 0.06, 0.07, 0.08, or 0.09. In some cases, B may be less than or equal to 0.09, 0.08, 0.07, 0.06, 0.05, 0.04, or 0.03. It may be preferred that B is in the range 0<β≤0.02. When lithium vacancies are present in the material, the electrochemical performance of the material may be improved. For example, one or more of the 1^{st} cycle columbic efficiency, the rate capability, or the capacity of the material may be improved when lithium vacancies are present. Such performance improvements might be attributed to the enhancement of Li conductivity due to the Li vacancies.

As set out in the general formula above, M comprises a transition metal element, and M′ comprises a redox-inactive d⁰ element. Each of M and M′ may comprise more than one element. In some embodiments, M consists of one or more transition metal elements. In some embodiments, M′ consists of one or more redox-inactive d⁰ elements. Where M′ comprises more than one element, y is the sum of the amount of each of the elements making up M′. Where M comprises more than one element, 1-x-y-β is the sum of the amount of each of the elements making up M.

The lithium metal oxide composition may optionally contain one or more dopant elements. In other words, the lithium metal oxide composition may contain one or more further elements present in dopant amounts. That is, M and/or M′ each optionally comprise an element other than a transition metal, or a redox-inactive d⁰ element, respectively. M may comprise a transition metal element and a doping element. M′ may comprise a redox-inactive d⁰ elements and a doping element. Where one or more dopant elements are present, they may be present in a molar ratio of 0.2 or less, 0.1 or less or 0.05 or less, the molar ratio being calculated with respect to the total molar amount of non-Li cations.

The presence of one or more doping elements in the composition may have a number of benefits. For example, the presence of one or more doping elements may help stabilise the material structure, thereby preventing oxygen loss during lithiation/delithiation. The presence of one or more doping elements may enhance the degree of cation disordering on the cation lattice, which may result in improved lithium conductivity. Finally, the presence of one or more doping elements may reduce the material cost, as some doping elements are more abundant and therefore cheaper than other elements which would typically make up M or M′.

M′ may comprise Ti, Nb, Mo, V, Zr, and any combination thereof. M′ may be selected from the group consisting of Ti, Nb, Mo, V, Zr, and any combination thereof. In some embodiments, M′ includes Nb and/or Ti. For example, M′ may consist of Nb, or may consist of Ti.

M may comprise Ni, Co, Mn, Cr, Fe and any combination thereof. M may be selected from the group consisting of Ni, Co, Mn, Cr, Fe and any combination thereof. In some embodiments, M comprises or consists of Mn. In some embodiments, M does not comprise Co. The natural abundance of Co is low, leading to high material cost. Providing a material which does not comprise Co can therefore reduce the overall cost of the material.

In some embodiments, the lithium metal oxide composition has the general formula Li₁₊ₓNb_{y}Mn_{1-x-y-β}O₂, or Li₁₊ₓTi_{y}Mn_{1-x-y-β}O₂. For example, the lithium metal oxide composition may be selected from the group consisting of:

Li_{1.30}Nb_{0.315}Mn_{0.375}O₂ (V_{Li}′=0.01)

Li_{1.30}Nb_{0.33}Mn_{0.35}O₂ (V_{Li}′=0.02)

Li_{1.2} Ti_{0.415}Mn_{0.38}O₂ (V_{Li}′=0.005)

Li_{1.2} Ti_{0.43}Mn_{0.36}O₂ (V_{Li}′=0.01)

In some preferred embodiments, the lithium metal oxide composition contains substantially no fluorine. Compositions containing substantially no fluorine may be easier to produce than comparative fluorinated materials.

The lithium metal oxide composition may comprise or consist of a plurality of particles. In some preferred cases, the lithium metal oxide composition may be a powder material, or be powdery in form (present as a plurality of fine, loose particles). Providing the lithium metal oxide composition as a powder can increase its industrial utility.

Where the lithium metal oxide composition comprises a plurality of particles, the average mean particle size may be from 0.5 μm to 20 μm, more preferably from 2 μm to 10 μm. In some cases, the mean particle size may be 1 μm or more, 2 μm or more, 3 μm or more, 4 μm or more, or 5 μm or more. In some cases, the mean particle size may be 15 μm or less, 10 μm or less, 9 μm or less, 8 μm or less, 7 μm or less, or 6 μm or less. In some cases, the mean particle size may be about 5 μm. The average mean particle size may be measured using any conventional technique, for example using SEM imaging to examine a sample of the material, selecting a number (n) of particles (which may be primary crystallites and/or secondary particles), and calculating the average size as the mean diameter of the n particles measured (e.g. the number of primary crystallites/secondary particles measured) (n may be e.g. 5, 10, 20, 30, 40, 50, or any other suitable number).

The lithium metal oxide composition may have a crystallite size as determined using a Rietveld refinement of the powder x-ray diffraction pattern of the lithium metal oxide material, which is greater than the respective crystallite size of an equivalent comparative material having no lithium vacancies, i.e. of an equivalent material of the general formula Li₁₊ₓM′_{y}M_{1-x-y}O₂. For example, for a material in the LiO_{1/2}-MnO_{3/2}—TiO₂ ternary system, the crystallite size of a comparative material having no lithium vacancies may be about 140 nm. For a material according to the present invention, the crystallite size may be 180 nm or more, for example 190 nm or more, 200 nm or more, 220 nm or more, 250 nm or more, or 270 nm or more. The crystallite size may be in a range of from about 200 nm to about 250 nm.

The lithium metal oxide composition may have a lattice parameter ‘a’, and/or a crystallographic unit cell volume ‘V’, which is similar to or less than the respective lattice parameter ‘a’ or the crystallographic unit cell volume ‘V’ of an equivalent comparative material having no lithium vacancies, i.e. of an equivalent material of the general formula Li₁₊ₓM′_{y}M_{1-x-y}O₂. For example, for a material in the LiO_{1/2}-Mn_{O3/2}-NbO_{5/2} ternary system, the lattice parameter ‘a’ of a comparative material having no lithium vacancies may be greater than 4.20 Å. For an equivalent material according to the present invention, the lattice parameter ‘a’ may be less than 4.20 Å, for example 4.199 Å or less, 4.198 Å or less, or 4.195 Å or less. For a material in the LiO_{1/2}-MnO_{3/2}—TiO₂ ternary system, the lattice parameter ‘a’ of a comparative material having no lithium vacancies may be greater than 4.15 Å. For an equivalent material according to the present invention, the lattice parameter ‘a’ may also be about 4.15 Å. The lattice parameter ‘a’, and the crystallographic unit cell volume ‘V’ may be determined in a conventional matter e.g. using X-ray powder diffraction (XRD) techniques.

The low temperature 1^{st} charge capacity of lithium metal oxide compositions according to the invention (defined as that measured at 23° C. in the 1^{st} cycle of a half cell test at a rate of C/50 between 1.5-4.8 V vs Li metal) may be 100 mAh/g or more, 110 mAh/g or more, 120 mAh/g or more, 150 mAh/g or more, 170 mAh/g or more, 180 mAh/g or more up, 190 mAh/g or more, or 200 mAh/g or more.

The low temperature 1^{st} discharge capacity of lithium metal oxide compositions according to the invention (defined as that measured at 23° C. in the 1^{st} cycle of a half cell test at a rate of C/50 between 1.5-4.8 V vs Li metal) may be may be greater than 30 mAh/g, for example they may be 31 mAh/g or more, 35 mAh/g or more, 50 mAh/g or more, 75 mAh/g or more, 100 mAh/g or more, 125 mAh/g or more up, 150 mAh/g or more, or 160 mAh/g or more.

The high temperature 1^{st} charge capacity of lithium metal oxide compositions according to the invention (defined as that measured at 60° C. in the 1^{st} cycle of a half cell test at a rate of C/50 between 1.5-4.8 V vs Li metal) may be 300 mAh/g or more, 310 mAh/g or more, 320 mAh/g or more, 330 mAh/g or more, 340 mAh/g or more or 350 mAh/g or more.

The high temperature 1^{st} discharge capacity of lithium metal oxide compositions according to the invention (defined as that measured at 60° C. in the 1^{st} cycle of a half cell test at a rate of C/50 between 1.5-4.8 V vs Li metal) may be 260 mAh/g or more, 265 mAh/g, or 270 mAh/g or more.

It may be advantageous to provide materials having a high charge and/or discharge capacity, as this can provide improved performance in an electrochemical device comprising the lithium metal oxide material.

The energy density of the lithium metal oxide material (calculated as the product of discharge capacity (mAh/g) and discharge mean voltage (V)) may be greater than 800 Wh/kg, for example 810 Wh/kg or more, 820 Wh/kg or more, 830 Wh/kg or more, 840 Wh/kg or more, 850 Wh/kg or more, or 860 Wh/kg or more.

The 1^{st} coulombic efficiency (1^{st} discharge capacity/1^{st} charge capacity) of lithium metal oxide compositions according to the invention may be larger than the 1^{st} coulombic efficiency (1^{st} discharge capacity/1^{st} charge capacity) of equivalent lithium metal oxide compositions containing no lithium vacancies. The 1^{st} coulombic efficiency of materials according to the invention may be 10% or more, 15% or more, or 20% or more higher than the 1^{st} coulombic efficiency of equivalent reference materials, The 1^{st} coulombic efficiency of lithium metal oxide compositions according to the invention may be 30% or more, for example: greater than 40%, greater than 50%, greater than 60%, greater than 70%, greater than 75%, or greater than 80%. In some cases, 1^{st} coulombic efficiency (1^{st} discharge capacity/1^{st} charge capacity) of lithium metal oxide compositions may be as high as 85% or more, e.g. 88% or more.

It may be advantageous to provide materials having a suitably high initial coulombic efficiency, as this can provide improved performance in an electrochemical device comprising the active electrode material.

The rate capability of lithium metal oxide compositions according to the invention may be improved compared to equivalent lithium metal oxide compositions containing no lithium vacancies. For example, the specific discharge capacity (C_{dis}) at rate C/50, C/20, C/10, and/or rate C/5 at 23° ° C. may be 10% or more, 20% or more, 30% or more, 40% or more, 50% or more, 60% or more, 70% or more, 80% or more, 90% or more, or 100% or more higher than the specific discharge capacity of equivalent reference materials. In some cases, the specific discharge capacity (C_{dis}) at rate C/50 at 23° C. may be 180 mAh/g or more. In some cases, the specific discharge capacity (C_{dis}) at rate C/20 at 23° C. may be 160 mAh/g or more. In some cases, the specific discharge capacity (C_{dis}) at rate C/10 at 23° C. may be 130 mAh/g or more. In some cases, the specific discharge capacity (C_{dis}) at rate C/5 at 23° C. may be 90 mAh/g or more. It is hypothesised that this improvement might result from an enhancement of Li conductivity during the lithiation/delithation mechanism.

In a second aspect, the present invention provides a method of synthesis of a lithium metal oxide composition of any one of the preceding claims, wherein the method includes steps of providing one or more precursor materials, mixing the precursor materials to form a precursor material mixture, and calcining the precursor material mixture to form the lithium metal oxide composition.

The precursor material(s) may include one or more metal oxides, metal hydroxides, metal salts or oxalates. In some preferred methods, each of the one or more precursor materials is a metal oxide. Where the desired lithium metal oxide composition has a composition within the LiO_{1/2}-MnO_{3/2}-NbO_{5/2} ternary system, the precursor materials may include Li₂CO₃, Nb₂O₅, and Mn₂O₃. Where the desired lithium metal oxide composition has a composition within the LiO_{1/2}-MnO_{3/2}—TiO₂ ternary system, the precursor materials may include Li₂CO₃, TiO₂ and Mn₂O₃.

The step of mixing said precursor materials to form a precursor material mixture may be performed by a milling process. For example, the mixing may be performed by planetary milling, roller ball milling, hand milling with mortar and pestle, or any other suitable milling process. In one preferred method, the mixing is performed by planetary milling 200 rpm for 15 mins×4, for a total milling time of 1 hour.

The calcination step may be performed in a temperature range from 400° C.-1400° C. For example, the calcination step may be carried out at a temperature of at least 400° C., at least 500° C., at least 600° C. or at least 650° C. The calcination step may be carried out at a temperature of 1400° ° C. or less, 1300° C. or less, 1200° ° C. or less, 1100° C. or less, or 1000° C. or less.

The precursor material mixture may be calcined for a period of between 15 minutes and 24 hours. For example, calcination may be performed for a period of at least 15 minutes, at least 30 minutes, at least 1 hour, at least 2 hours, at least 4 hours, at least 6 hours, or at least 10 hours. Calcination may be performed for a period of no more than 24 hours, no more than 18 hours, no more than 15 hours, or no more than 12 hours.

Calcination may be performed in a gaseous atmosphere, the gas being selected from air, N₂, Ar, He, CO₂, CO, O₂, H₂, and mixtures thereof. Preferably, the gaseous atmosphere is an inert atmosphere. In preferred methods, the gaseous atmosphere is an Ar atmosphere.

The method may include one or more post-processing steps after formation of the lithium metal oxide composition. For example, the method may include a step of grinding the lithium metal oxide, for example using a pestle and mortar for small scale applications, or any suitable grinding or milling process for larger-scale applications: e.g. by use of a ball mill, a planetary ball mill or a rolling bed mill. The grinding or milling may be carried out until the particles reach a predetermined desired size. Performing a grinding or milling step may provide a more suitable particle size for use in desired applications of the lithium metal oxide composition.

After formation of the lithium metal oxide composition, the composition may be processed for use in various applications. One typical application is in the formation of electrodes for use in batteries such as secondary (rechargeable) batteries, for example in lithium (e.g. lithium ion) batteries.

Accordingly, in a third aspect, the present invention provides the use of the lithium metal oxide composition in the formation of an electrode for a battery. The battery may be a secondary (rechargeable) battery. The battery may be a lithium (e.g. lithium ion) battery. Another preferred application of such material is in as a cathode active material, or a component of a cathode active material, in a cathode in conjunction with an anode and an electrolyte in a lithium ion battery for charging and discharging of the lithium ion battery. This can be considered to be a further aspect of the present invention. Depending on the precise composition of the lithium metal oxide composition, it may be more suitable for use at lower temperatures, or at higher temperatures. Accordingly, the use may be at a lower temperature in the range of about 0° C. to about 40° C. (e.g. about 23°) C. Alternatively or additionally, the use may be at a higher temperature in the range of about 50° C. to about 100° C. (e.g. about 60°) C. In other words, the use may include operation of the battery at such temperatures.

In a fourth aspect, the present invention provides an electrode comprising the lithium metal oxide composition of the first aspect. Such an electrode may further comprise a binder and/or a carbon material. The electrode may be made in a conventional manner, e.g. by forming a slurry comprising the lithium metal oxide material, applying the slurry to the surface of a current collector (e.g. an aluminium current collector), and optionally processing (e.g. calendaring) to increase the density of the electrode. The slurry may comprise one or more of a solvent, a binder, carbon material and further additives. The composition of the electrode is not particularly limited, but in some preferred embodiments, the electrode has a composition of about 80 wt % active material (lithium metal oxide composition), about 10 wt % conductive additive (e.g. carbon material such as C65 carbon black), and about 10 wt % binder (e.g. PVDF).

In a fifth aspect, the present invention provides a battery or electrochemical cell comprising the electrode of the fourth aspect. The battery or cell typically further comprises an anode and an electrolyte. The battery or cell may typically be a secondary (rechargeable) lithium (e.g. lithium ion) battery.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a ternary phase diagram of the LiO_{1/2}-MnO_{3/2}-NbO_{5/2} system, indicating some compositions having lithium vacancies.

FIG. 2 is a ternary phase diagram of the LiO_{1/2}-MnO_{3/2}—TiO₂ system, indicating some compositions having lithium vacancies.

FIGS. 3 (a)-(c) show XRD results for samples in the LiO_{1/2}-MnO_{3/2}-NbO_{5/2} system having different amounts of lithium vacancies after calcination at 1000° C. in Ar

FIG. 4 shows (a) SEM and (b) back scattered images for Li_{1.30}Nb_{0.315}Mn_{0.375}O₂ (VLi′=0.01).

FIGS. 5 (a)-(c) show XRD results for sample compositions in the LiO_{1/2}-MnO_{3/2}—TiO₂ system having different amounts of lithium vacancies after calcination at 1000° C. in Ar.

FIG. 6 shows the results of electrochemical testing for samples in the LiO_{1/2}-MnO_{3/2}-NbO_{5/2} system having different amounts of lithium vacancies: (a) and (b) when V_{Li}′=0, (c) and (d) V_{Li}′=0.01, (e) and (f) V_{Li}′=0.02.

FIG. 7 show the results of electrochemical testing at low vs high temperatures for Li_{1.3}Nb_{0.315}Mn_{0.375}O₂ (V_{Li′}=0.01) and Li_{1.3}Nb_{0.33}Mn_{0.35}O₂ (V_{Li}′=0.02) against Li_{1.3}Nb_{0.3}Mn_{0.4}O₂ (V_{Li′}=0) as a reference sample: 1^{st} charge/discharge profile at (a) 23° C. and (b) 60° C.; 1^{st} dQ/dv at (c) 23° ° C. and (d) 60° C.; discharge capacity as function of cycle number at (e) 23° C. and (f) 60° C.; and charge/discharge mean voltage as function as cycle number at (g) 23° C. and (h) 60° C.

FIG. 8 shows (a) 1^{st} charge/discharge profile; (b) 1^{st} dQ/dv; (c) discharge capacity as function of cycle number; and (d) charge/discharge mean voltage as function as cycle number, for samples in the LiO_{1/2}-MnO_{3/2}—TiO₂ system with lithium vacancies, Li_{1.2} Ti_{0.415}Mn_{0.38}O₂ (V_{Li′}=0.005) and Li_{1.2}Ti_{0.43}Mn_{0.36}O₂ (V_{Li′}=0.01) against Li_{1.2}Ti_{0.4}Mn_{0.4}O₂ as a reference sample—all results at 23° C.

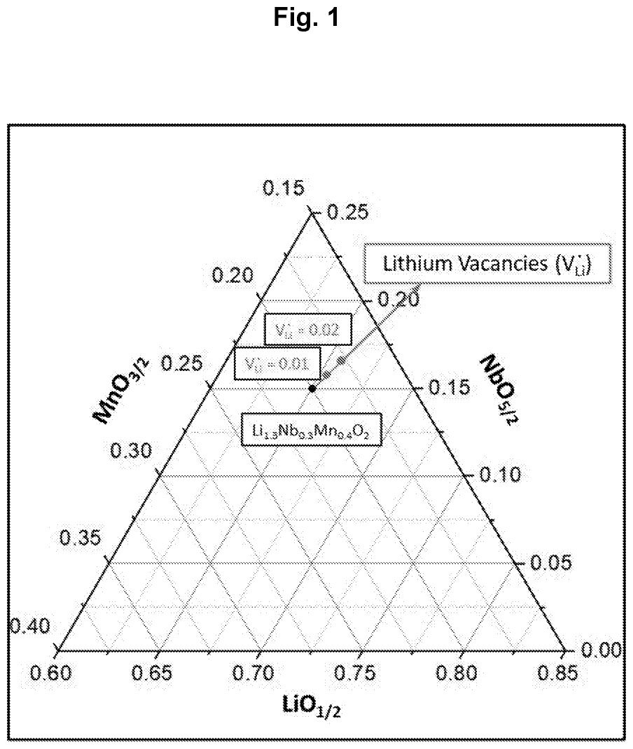

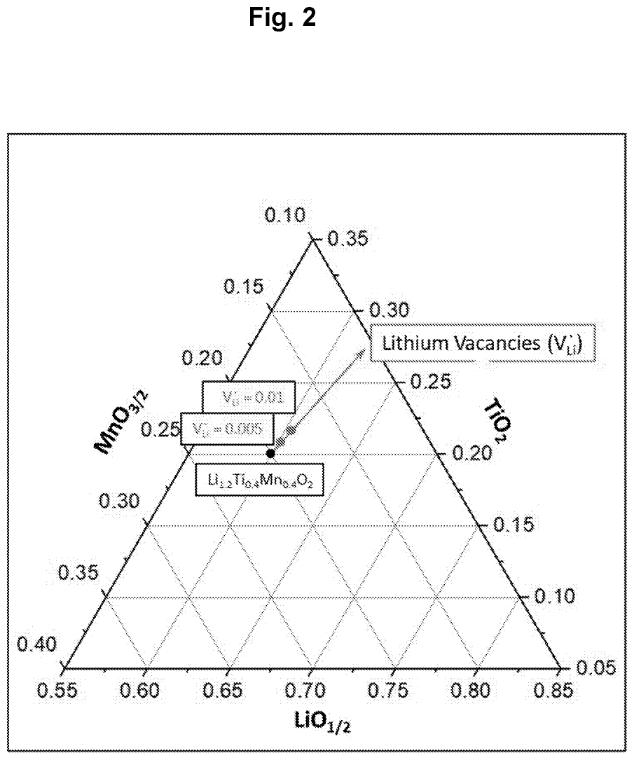

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

In order to exemplify the invention, various material have been produced and characterised. To date current research has focused on materials having compositions within the LiO_{1/2}-MnO_{3/2}-NbO_{5/2} and LiO_{1/2}-MnO_{3/2}—TiO₂ systems, although it is considered that similar results would also be observed in other ternary systems capable of forming disordered rock salt structures as discussed above.

Material Synthesis & Characterisation—LiO_{1/2}-Mn_{O3/2}-NbO_{5/2} Ternary System

Li₂CO₃, Nb₂O₅, and Mn₂O₃ were used as raw materials for synthesizing disordered rock salt cathode materials according to target formulations as set out in Table 1:

TABLE 1
Details of Non-stoichiometric Disordered Rocksalt samples
in LiO_{1/2}—Mn_{O3/2}—NbO_{5/2} ternary system

| Sample Ref. | Formulation | Charge compensation mechanism |
|---|---|---|
| LNM-03 | Li_{1.3}Nb_{0.3}Mn_{0.4}O₂ | — |
| (reference) | | |
| LNM-NS-07 | Li_{1.30}Nb_{0.315}Mn_{0.375}O₂ | Lithium Vacancies, V_{Li}′ = 0.01 |
| LNM-NS-08 | Li_{1.30}Nb_{0.33}Mn_{0.35}O₂ | Lithium Vacancies, V_{Li}′ = 0.02 |

To make the samples, the following method was followed:
a) Raw materials were weighed out in appropriate proportions according to sample formula, before being transferred to a sample jar;
b) A planetary milling process was applied for mixing of the raw materials (250 ml Zirconium Oxide milling pot was used with 50 zirconium milling medias (10 mm in diameter)): all raw materials were transferred to the milling pot, before a lid was put on and covered with tape. Milling was performed at 200 rpm for 15 mins×4.
c) After mixing, the mixture was collected from the milling pot and loaded into an alumina crucible. Calcination was performed in a furnace at 1000° C. in Ar for 12 hours with ramping rate of 5° C./min.
d) After calcination, the sample was removed from the furnace at room temperature, and optionally stored in a vacuum desiccator, before being ground using a mortar and pestle, and sieved through a 50 μm mesh.
e) The sieved powder sample was collected for characterisation.

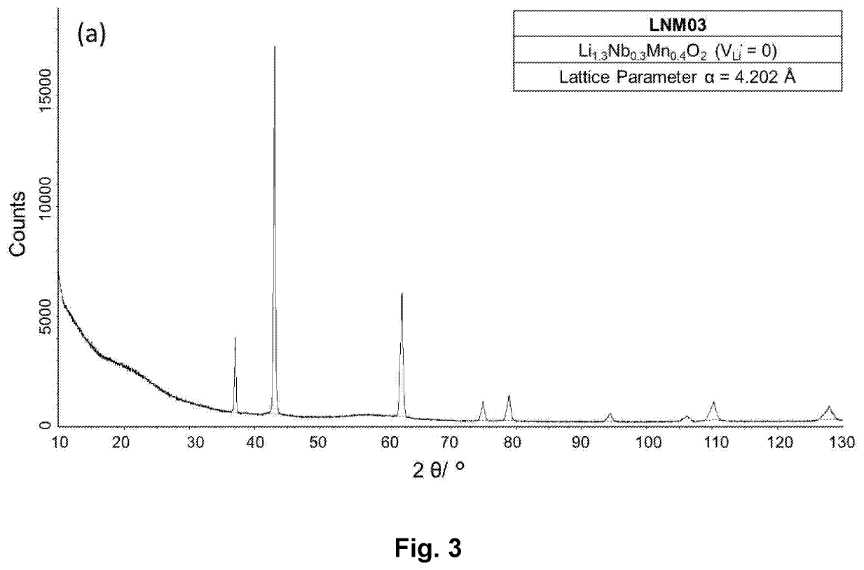

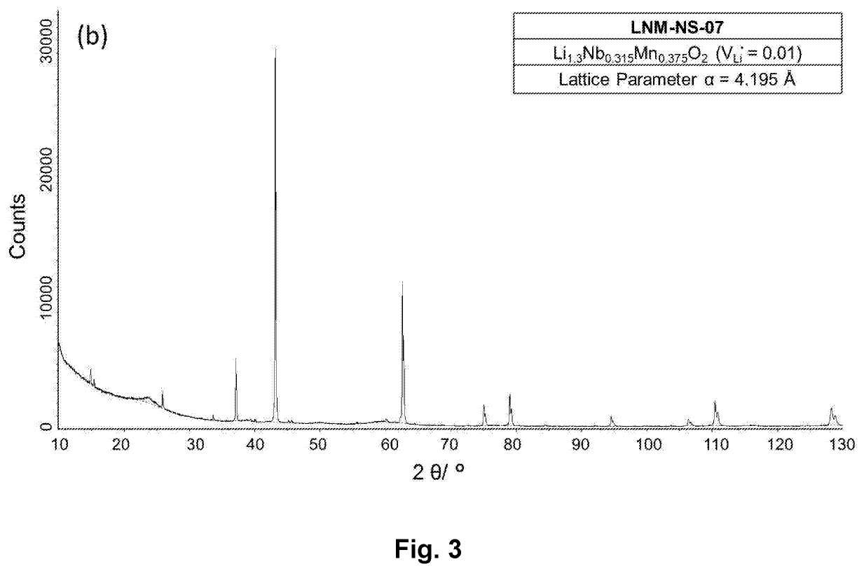

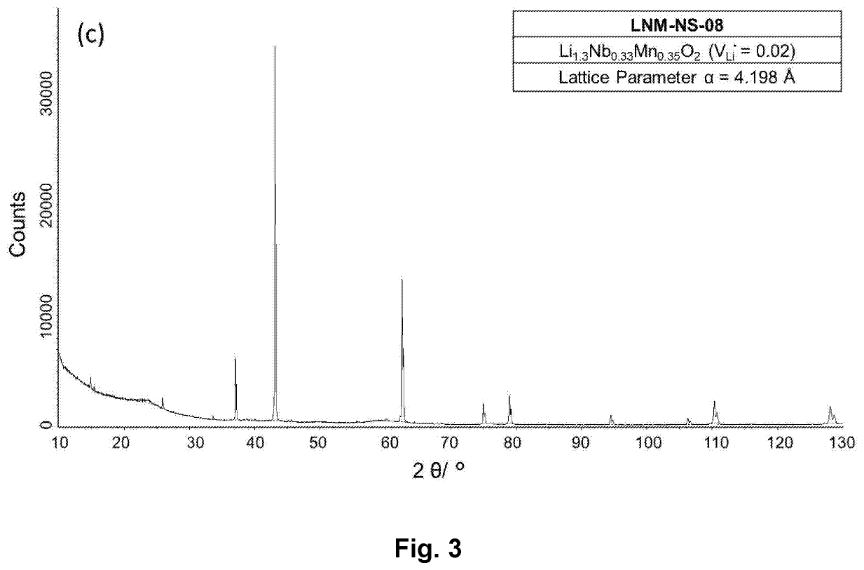

Powder sample X-Ray Diffraction (XRD) test, 2θ between 0 and 130°, were first carried out for phase purity and lattice parameter fittings, and results are shown in FIG. 3. XRD data was collected in reflection geometry using a Bruker AXS D8 diffractometer using Cu Kα radiation (λ=1.5406+1.5444 Å). Phase identification was conducted using Bruker AXS Diffrac Eva V5 (2019) with reference to the PDF-4+ database, to ensure that all of the observed scattering could be assigned to known crystal structures. Rietveld refinement was performed using a complete-powder diffraction pattern fitting technique using a full structural model. The crystallite sizes of the assigned phase have been calculated using the volume weighted column height LVol-IB method.

Specifically, FIG. 3(a) is an XRD trace of the reference sample Li_{1.3}Nb_{0.3}Mn_{0.4}O₂. The lattice parameter for this material was found to be 4.202 Å. FIG. 3(b) is an XRD trace of Li_{1.30}Nb_{0.315}Mn_{0.375}O₂ Lithium Vacancies, V_{Li}′=0.01. The lattice parameter for this material was found to be 4.195 Å. FIG. 3(c) is an XRD trace of Li_{1.30}Nb_{0.33}Mn_{0.35}O₂ Lithium Vacancies, V_{Li}′=0.02. The lattice parameter for this material was found to be 4.198 Å. It can be seen from these XRD traces that a major phase of disordered rock salt structure was obtained in all samples.

The change of the lattice parameter (a) as a function of lithium vacancies (V_{Li′}), was found to be negligible, although slightly smaller in materials having lithium vacancies than in the comparative reference material. This minor decrease of the lattice parameter may be attributable to the present of the lithium vacancies.

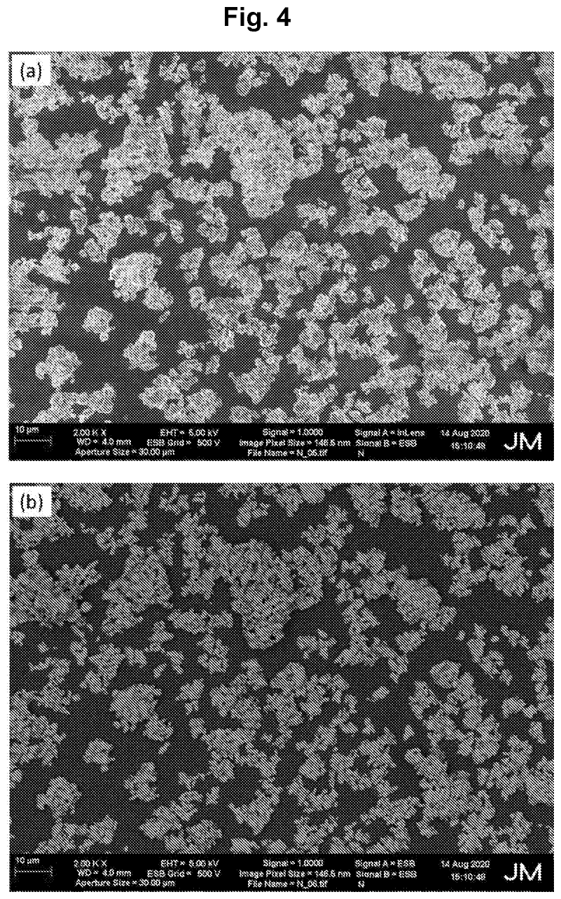

SEM characterisation was also carried out to determine particle morphologies and sizes. FIG. 4 shows (a) SEM and (b) back scattered images for Li_{1.30}Nb_{0.315}Mn_{0.375}O₂ (VLi″=0.01). These images were selected as representative samples. Particle sizes in a range of between about 2 μm and about 10 μm were observed. Backscattered images were also taken, and no secondary phases were observed, as shown in FIG. 4(b).

Material Synthesis & Characterisation—LiO_{1/2}-MnO_{3/2}—TiO₂ Ternary System

Li₂CO₃, TiO₂, and Mn₂O₃ were used as raw materials for synthesizing disordered rock salt cathode materials according to target formulations as set out in Table 2:

TABLE 2
Details of Non-stoichiometric Disordered Rocksalt samples
in LiO_{1/2}—MnO_{3/2}—TiO₂ ternary system

| Sample Ref. | Formulation | Charge compensation mechanism |
|---|---|---|
| LTM-03 | Li_{1.2}Ti_{0.4}Mn_{0.4}O₂ | None |
| (reference) | | |
| LTM-NS-03 | Li_{1.2}Ti_{0.415}Mn_{0.38}O₂ | Li Vacancies, V_{Li}′ = 0.005 |
| LTM-NS-04 | Li_{1.2}Ti_{0.43}Mn_{0.36}O₂ | Li Vacancies, V_{Li}′ = 0.01 |

Samples were synthesised following a method as set out above (i.e. by calcination at 1000° C. in Ar atmosphere for 12 hours via solid state reaction after mixing using ball milling at 200 rpm for 1 hour), and then characterised.

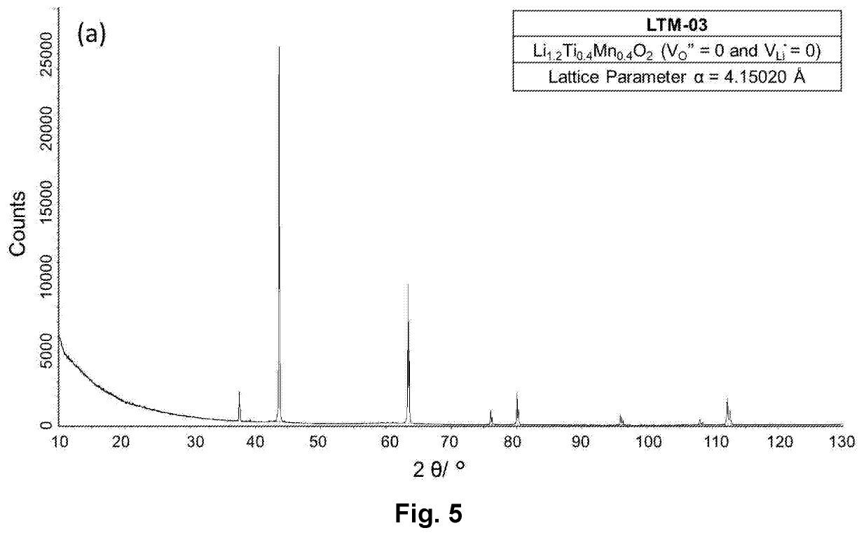

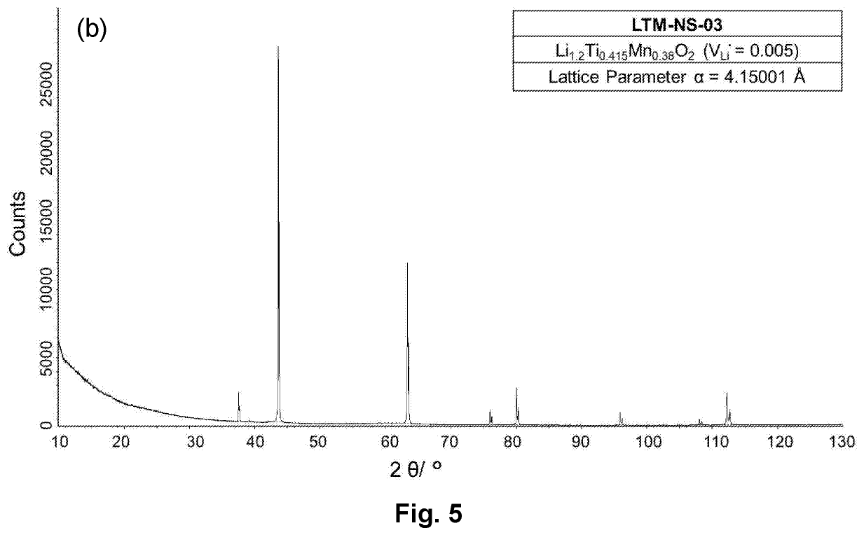

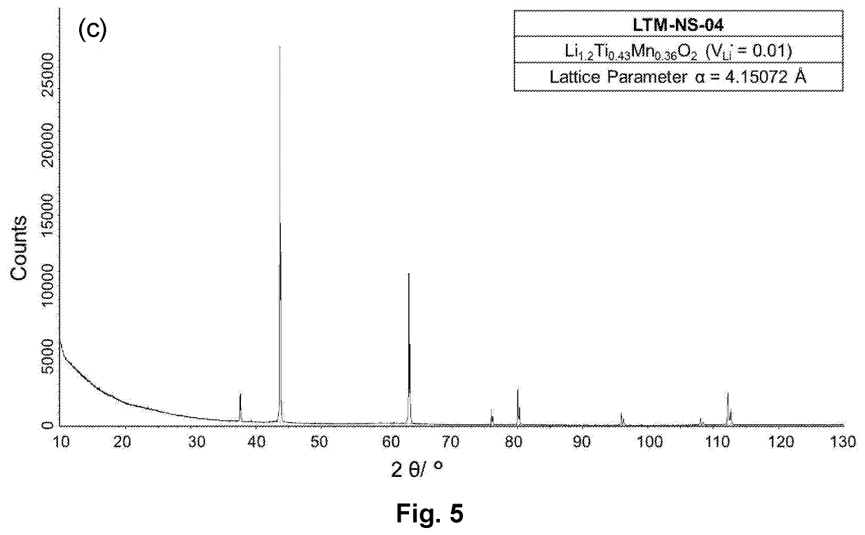

FIGS. 5 (a)-(c) show XRD results for sample compositions in the LiO_{1/2}-MnO_{3/2}—TiO₂ system having different amounts of lithium vacancies after calcination at 1000° C. in Ar.

Specifically, FIG. 5(a) is an XRD trace of the reference sample Li_{1.2}Ti_{0.4}Mn_{0.4}O₂. FIG. 5(b) is an XRD trace of Li_{1.2} Ti_{0.415}Mn_{0.38}O₂, Li Vacancies, V_{Li′}=0.005. FIG. 5(c) is an XRD trace of Li_{1.2}Ti_{0.43}Mn_{0.36}O₂, Li Vacancies, V_{Li}′=0.01. It can be seen from these XRD traces that a major phase of disordered rock salt structure was obtained in all samples.

Negligible change in the lattice parameter a was observed when lithium vacancies were present in samples, as seen in Table 3. However, the crystallite size was observed to increase where lithium vacancies were present.

TABLE 3
lattice parameter (a) and crystal size (C.S.) of non-stoichiometric
DRX samples in LiO_{1/2}—MnO_{3/2}—TiO₂ ternary system. Crystallite
size calculated using the LVol-IB method, based on XRD results.
The numbers given in parenthesis are the error deviation
in the given results for crystallite size.

| Sample Ref. | a/Å | C.S./nm (error deviation) |
|---|---|---|
| LTM-03 (reference) | 4.150 | 141(6) |
| LTM-NS-03 | 4.150 | 246(18) |
| LTM-NS-04 | 4.151 | 201(13) |

Electrochemical performance—LiO_{1/2}-Mn_{O3/2}-NbO_{5/2} Ternary System

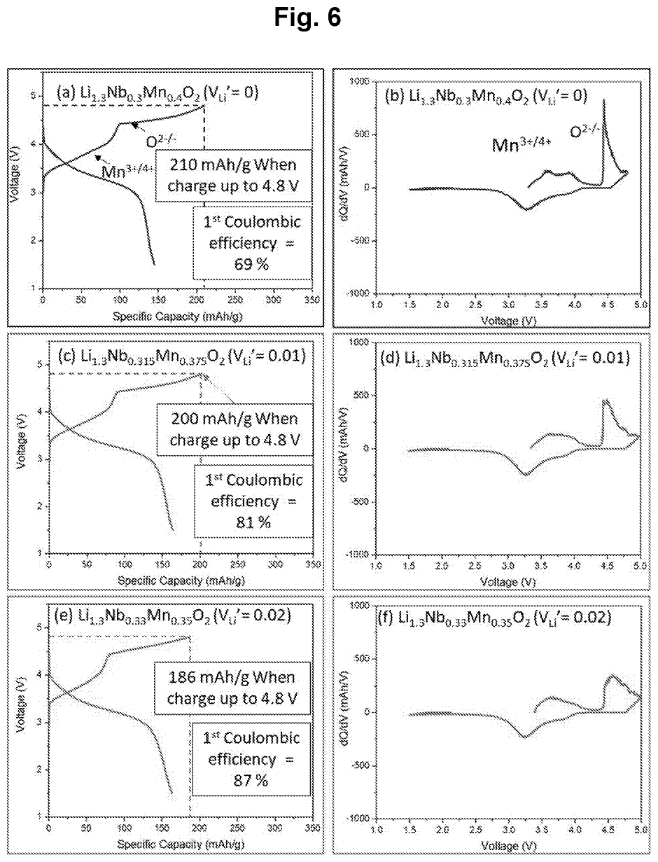

After synthesis and material characterisation, electrochemical characterisation was performed on the samples. Cathode electrodes were prepared using active materials, PVDF binder and C65 with a weight ratio of 80:10:10. The electrochemical properties of the samples were then characterised using half-cell against Li metal between 1.5-4.8 V with various charging rate at 23° C. LP30 was used as electrolyte. FIG. 6 shows the results of electrochemical testing for samples in the LiO_{1/2}-MnO_{3/2}-NbO_{5/2} system having different amounts of lithium vacancies: (a) and (b) when V_{Li′}=0, (c) and (d) V_{Li′}=0.01, (e) and (f) V_{Li}′=0.02.

Similar charge capacities of about 200 mAh/g were obtained from all samples, however an improvement in discharge capacities from about 145 mAh/g in the reference sample, to 160-170 mAh/g in the lithium-vacancy samples was observed. Additionally, the corresponding 1^{st} columbic efficiency was improved from 69% when V_{Li′}=0 to about 87% when V_{Li′}=0.02. The process of lithiation and delithiation (discharging and charging) of battery materials depends both on the prevalence of redox species within the material, as well as on the Li conductivity within the material. Without wishing to be bound by theory, the present inventors suggest that no significant increase of charging capacities were observed in samples according to the invention vs reference samples due to the similar amount of redox species present in all samples. However, the improvement in discharge capacities seen may result from higher Li conductivity in samples having lithium vacancies in comparison to the reference samples.

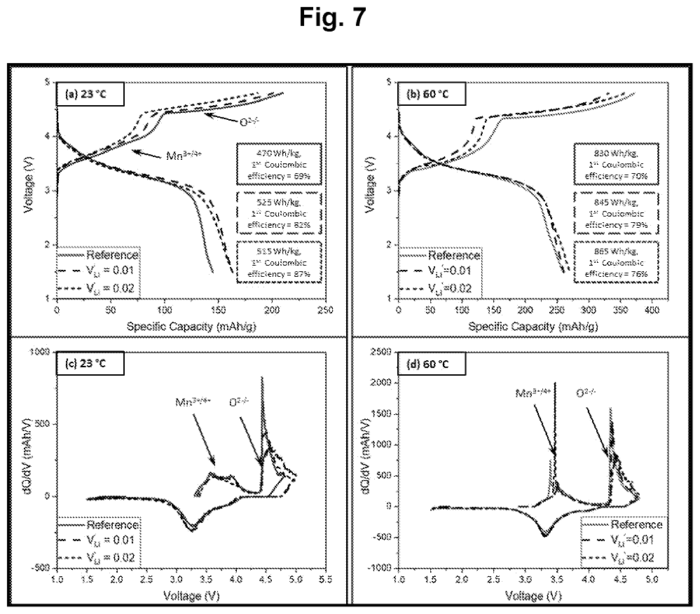

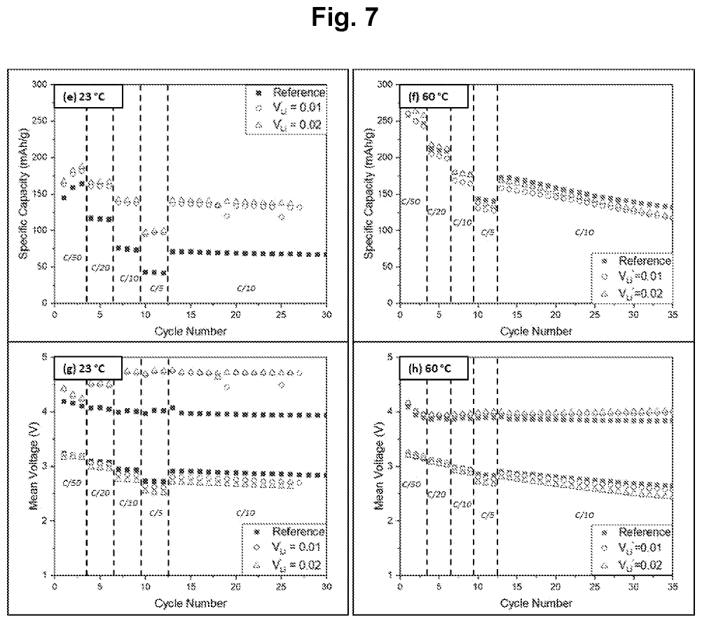

To investigate the effect of temperature on the electrochemical performance, a comparative study comparing performance at 23° C. and 60° C. was also performed. FIG. 7 shows the results of electrochemical testing at low vs high temperatures for Li_{1.3}Nb_{0.315}Mn_{0.375}O₂ (V_{Li′}=0.01) and Li_{1.3}Nb_{0.33}Mn_{0.35}O₂ (V_{Li}′=0.02) against Li_{1.3}Nb_{0.3}Mn_{0.4}O₂ (V_{Li}′=0) as a reference sample: 1^{st} charge/discharge profile at (a) 23° C. and (b) 60° C.; 1^{st} dQ/dv at (c) 23° C. and (d) 60° C.; discharge capacity as function of cycle number at (e) 23° C. and (f) 60° C.; and charge/discharge mean voltage as function as cycle number at (g) 23° C. and (h) 60° C.

Results for 1^{st} cycle charge and discharge capacities, as well as 1^{st} coulombic efficiencies for the samples tested at room temperature)(23° ° C. are shown below:

TABLE 4
Room Temperature (23° C.) capacity &
1^{st} coulombic efficiency of various compositions

| | | Capacity of 1^{st} | | |
|---|---|---|---|---|
| | | cycle at C/50 | | 1st |
| Sample | | Charge | Discharge | Coulombic |
| Ref. | Formula | (mAh/g) | (mAh/g) | Efficiency |
| LNM03 | Li_{1.30}Nb_{0.3}Mn_{0.4}O₂ | 210 | 145 | 69% |
| (reference) | (V_{Li}′ = 0) | | | |
| LNM-NS- | Li_{1.30}Nb_{0.315}Mn_{0.375}O₂ | 201 | 164 | 82% |
| 07 | (V_{Li}′ = 0.01) | | | |
| LNM-NS- | Li_{1.30}Nb_{0.33}Mn_{0.35}O₂ | 187 | 163 | 87% |
| 08 | (V_{Li}′ = 0.02) | | | |

Results for 1^{st} cycle charge and discharge capacities, as well as 1^{st} coulombic efficiencies for the samples tested at high temperature (60° C.) are shown below:

TABLE 5
High Temperature (60° C.) capacity &
1^{st} coulombic efficiency of various compositions.

| | | Capacity of 1^{st} | | |
|---|---|---|---|---|
| | | cycle at C/50 | | 1st |
| Sample | | Charge | Discharge | Coulombic |
| Ref. | Formula | (mAh/g) | (mAh/g) | Efficiency |
| LNM03 | Li_{1.30}Nb_{0.3}Mn_{0.4}O₂ | 372 | 260 | 70% |
| (reference) | (V_{Li}′ = 0) | | | |
| LNM-NS- | Li_{1.30}Nb_{0.315}Mn_{0.375}O₂ | 331 | 260 | 79% |
| 07 | (V_{Li}′ = 0.01) | | | |
| LNM-NS- | Li_{1.30}Nb_{0.33}Mn_{0.35}O₂ | 357 | 270 | 76% |
| 08 | (V_{Li}′ = 0.02) | | | |

Similarly to the results shown in FIG. 6, it can be seen that the 1^{st} coulombic efficiency (1^{st} discharge capacity/1^{st} charge capacity) was significant improved from 69% for reference sample to 82% for the sample with V_{Li}′=0.01, and to 88% for the sample with V_{Li}′=0.02 when tested at 23° C., as seen in FIG. 7(a). The 1^{st} coulombic efficiency as also increased at 60° C.—from 70% for the reference sample, to 79% and 76% for the V_{Li}′=0.01 and V_{Li′}=0.02 lithium vacancy samples respectively.

Moreover, the rate capability was remarkable improved when lithium vacancies were present in samples when tested at 23° C., as shown in FIG. 7(e). For instance, at C/10, discharge capacity (C_{dis}) of reference sample was ˜ 73 mAh/g compared to C_{dis}˜ 140 mAh/g for samples with lithium vacancies. It is hypothesised that this improvement might result from an enhancement of Li conductivity during the lithiation/delithation mechanism. The values for specific discharge capacity of the samples shown in FIG. 7(e) are presented in Table 6, below:

TABLE 6
Specific Discharge Capacity at 23° C. at
various charging rates for various compositions

| | Specific Discharge Capacity (mAh/g) at 23° C. | | | |
|---|---|---|---|---|
| Sample Ref. | C/50 | C/20 | C/10 | C/5 |
| Reference (V_{Li}′ = 0) | 164 | 115 | 73 | 42 |
| Li_{1.30}Nb_{0.3}Mn_{0.4}O₂ | | | | |
| Li_{1.30}Nb_{0.315}Mn_{0.375}O₂ | 181 | 160 | 137 | 97 |
| (V_{Li}′ = 0.01) | | | | |
| Li_{1.30}Nb_{0.33}Mn_{0.35}O₂ | 188 | 167 | 141 | 100 |
| (V_{Li}′ = 0.02) | | | | |

Electrochemical Performance—LiO_{1/2}-Mn_{O3/2}-NbO_{5/2} Ternary System

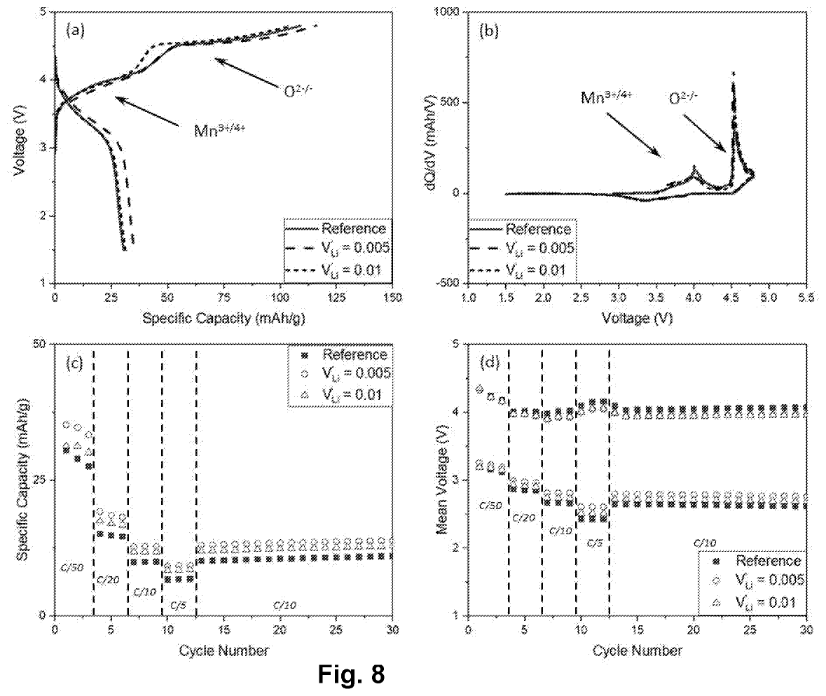

After synthesis and material characterisation, electrochemical characterisation was performed on the samples. Cathode electrodes were prepared using active materials, PVDF binder and C65 with a weight ratio of 80:10:10. The electrochemical properties of the samples were then characterised using half-cell against Li metal between 1.5-4.8 V with various charging rate at 23° C. LP30 was used as electrolyte. For samples with lithium vacancies (V_{Li}′), the electrochemical results tested at 23° C. are shown in FIG. 8. FIG. 8 shows (a) 1^{st} charge/discharge profile; (b) 1^{st} dQ/dv; (c) discharge capacity as function of cycle number; and (d) charge/discharge mean voltage as function as cycle number, for samples in the LiO_{1/2}-MnO_{3/2}—TiO₂ system with lithium vacancies: Li_{1.2}Ti_{0.415}Mn_{0.38}O₂ (V_{Li}′=0.005) and Li_{1.2}Ti_{0.43}Mn_{0.36}O₂ (V_{Li}′=0.01) against Li_{1.2}Ti_{0.4}Mn_{0.4}O₂ as a reference sample—all results at 23° C.

TABLE 7
Room Temperature (23° C.) capacity &
1^{st} coulombic efficiency of various compositions

| | | Capacity of 1^{st} | | |
|---|---|---|---|---|
| | | cycle at C/50 | | 1st |
| Sample | | Charge | Discharge | Coulombic |
| Ref. | Formula | (mAh/g) | (mAh/g) | Efficiency |
| LTM03 | Li_{1.20}Ti_{0.4}Mn_{0.4}O₂ | 190 | 30 | 16% |
| (reference) | (V_{Li}′ = 0) | | | |
| LTM-NS-03 | Li_{1.2}Ti_{0.415}Mn_{0.38}O₂ | 116 | 35 | 30% |
| | (V_{Li}′ = 0.005) | | | |
| LTM-NS-04 | Li_{1.2}Ti_{0.43}Mn_{0.36}O₂ | 105 | 31 | 30% |
| | (V_{Li}′ = 0.01) | | | |

It can be seen from these figures that the discharge capacities were somewhat improved in the lithium-vacancy containing material comparing to the reference materials, e.g. about 30 mAh/g for the reference material (V_{Li}=0) in comparison to about 35 mAh/g for the sample in which V_{Li}′=0.005 (see FIG. 8(a).

Furthermore, the rate capability was improved when lithium vacancies were present in samples when tested at 23° C.—see FIG. 8(c), as well as Table 8, below, which provides values for specific discharge capacity of the samples shown in FIG. 8(c):

TABLE 8
Specific Discharge Capacity at 23° C. at
various charging rates for various compositions

| | Specific Discharge Capacity (mAh/g) at 23° C. | | | |
|---|---|---|---|---|
| Sample Ref. | C/50 | C/20 | C/10 | C/5 |
| Reference (V_{Li}′ = 0) | 30 | 15 | 10 | 7 |
| Li_{1.20}Ti_{0.4}Mn_{0.4}O₂ | | | | |
| Li_{1.30}Nb_{0.315}Mn_{0.375}O₂ | 35 | 19 | 13 | 9 |
| (V_{Li}′ = 0.005) | | | | |
| Li_{1.30}Nb_{0.33}Mn_{0.35}O₂ | 31 | 17 | 12 | 8 |
| (V_{Li}′ = 0.01) | | | | |

In general, there is good agreement between the enhanced electrochemical performance seen in this ternary system with the enhanced performance seen in the LiO_{1/2}-Mn_{O3/2}-NbO_{5/2} system.

### Summary of Key Findings

The present work shows that provision of non-stoichiometric lithium metal oxides having a disordered rock salt structure may provide satisfactory, improved or excellent electrochemical performance, in comparison to stoichiometric reference materials. This has been exemplified for materials having compositions within the LiO_{1/2}-MnO_{3/2}-NbO_{5/2} and LiO_{1/2}-MnO_{3/2}—TiO₂ ternary systems.

In both systems, the 1^{st} cycle columbic efficiencies were improved, and the rate capability and capacities were also remarkably enhanced especially at room temperature when lithium vacancies were present in the sample. These phenomena might assign to the enhancement of Li conductivity due to the Li vacancies.

As similar results were seen across both studied systems, it is therefore considered that these teachings would also apply more generally to other compositional systems capable of forming disordered rock salt structures.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A lithium metal oxide composition having a general formula: Li₁₊ₓM′_{y}M_{1-x-y-β}O₂, wherein M comprises a transition metal element, M′ comprises a redox-inactive d⁰ element, wherein:
0<x≤0.7,
0<y≤0.7,
0<β≤0.1
and wherein the lithium metal oxide has a cation-disordered rock salt structure.

2. The lithium metal oxide composition according to claim 1 wherein 0<β≤0.02.

3. The lithium metal oxide composition according to claim 1 or claim 2 wherein 0<y≤0.4.

4. The lithium metal oxide composition according to any one of the preceding claims wherein M consists of one or more transition metal elements, and wherein M′ consists of one or more redox-inactive d⁰ elements.

5. The lithium metal oxide composition according to any one of the preceding claims, wherein M is selected from the group consisting of Ni, Co, Mn, Cr, Fe and any combination thereof.

6. The lithium metal oxide composition according to any one of the preceding claims wherein M′ is selected from the group consisting of Ti, Nb, Mo, V, Zr, and any combination thereof.

7. The lithium metal oxide composition according to any one of the preceding claims wherein the material contains substantially no fluorine.

8. The lithium metal oxide composition according to any one of the preceding claims, wherein the composition has the general formula Li₁₊ₓNb_{y}Mn_{1-x-y-β}O₂, or Li₁₊ₓTi_{y}Mn_{1-x-y-β}O₂.

9. The lithium metal oxide composition according to claim 8 wherein the composition is selected from the group consisting of:
Li_{1.30}Nb_{0.315}Mn_{0.375}O₂ (V_{Li}′=0.01)
Li_{1.30}Nb_{0.33}Mn_{0.35}O₂ (V_{Li}′=0.02)
Li_{1.2} Ti_{0.415}Mn_{0.38}O₂ (V_{Li}′=0.005)
Li_{1.2} Ti_{0.43}Mn_{0.36}O₂ (V_{Li}′=0.01)

10. The lithium metal oxide composition according to any one of the preceding claims wherein the energy density of the lithium metal oxide material is greater than 800 Wh/kg.

11. The lithium metal oxide composition according to any one of the preceding claims wherein the 1^{st} coulombic efficiency (1^{st} discharge capacity/1^{st} charge capacity) is greater than 70%

12. A method of synthesis of a lithium metal oxide composition according to any one of the preceding claims, wherein the method includes steps of:
providing one or more precursor materials, and mixing the precursor materials to form a precursor material mixture;
calcining the precursor material mixture to form the lithium metal oxide composition.

13. The method according to claim 12, wherein the precursor materials include one or more metal oxides, metal hydroxides, metal salts or oxalates.

14. The method according to claim 12 or claim 13 wherein the step of mixing said precursor materials to form a precursor material mixture is performed by planetary milling.

15. The method according to any one of claims 12 to 14 wherein calcination is performed in a temperature range from 400° C.-1400° C.

16. The method according to any one of claims 12 to 15 wherein calcination is performed for a period of between 15 minutes and 24 hours.

17. The method according to claims wherein calcination is performed in a gaseous atmosphere, the gas being selected from air, N₂, Ar, He, CO₂, CO, O₂, H₂, and mixtures thereof.

18. An electrode comprising the lithium metal oxide composition of any one of claims 1 to 11.

19. The electrode of claim 18, wherein the electrode further comprises one or more of carbon black and a binder material.

20. A battery or electrochemical cell comprising the electrode of claim 18 or claim 19.

21. Use of the lithium metal oxide composition according to any one of claims 1 to 11 in the formation of an electrode for a battery.

22. Use of the lithium metal oxide composition according to any one of claims 1 to 11 as a cathode active material, or a component of a cathode active material, in a cathode in conjunction with an anode and an electrolyte in a lithium ion battery for charging and discharging of the lithium ion battery.
